(19) United States
(12) Patent Application Publication
(10) Pub. No.: US 2003/0076784 A1
(43) Pub. Date: Apr. 24, 2003

(54) Methods of performance estimation in provisioning delay intolerant data services

(75) Inventors: D.C. John Ta, Laguna Niguel, CA (US); Jim Kosolowski, Woodlawn (CA)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA

(21) Appl. No.: 10/036,153

(22) Filed: Oct. 24, 2001

(51) Int. Cl. H04L 12/26

(52) U.S. Cl. 370/250; 370/389

(57) ABSTRACT

Methods and apparatus for evaluating the performance of data switching equipment in processing and conveying, delay, jitter and loss sensitive streams of data are provided. The apparatus includes receive trace records and transmit trace records and the methods include the inspection of the receive and transmit trace records to evaluate the performance of the data switching equipment. The advantages include the availability of an assessment of data transport latencies, data conveyance jitter and data segment loss to enable the provisioning of streaming data services.

### FIELD OF THE INVENTION

The invention relates to data transport across data transport networks, and in particular to methods and apparatus for performance evaluation in provisioning transport delay sensitive data services.

### BACKGROUND OF THE INVENTION

In the field of telecommunications streaming data services are more and more in demand. Streaming data services include: audio, video, and data streaming.

Audio streaming, more commonly known as voice services, include: the ubiquitous Plain Old Telephone Service (POTS), audio-conferencing, radio, etc. The POTS service has been delivered via local loops which are copper pair connections from a local exchange telephone switch to each telephone station. A group of interconnected telephone switches make up what is known as the telephone network. Recent trends however have led to wireless telephone sets. Audio-conferencing has been provided via telephone switch services on a need to use basis. The radio service has until recently been delivered over the free space radio waves.

Video streaming services include: television programming, video-conferencing, and recently video-on-demand. Television programming has been initially, and still is, delivered via free space radio waves but recently television programming is delivered more and more via wire-line services including cable television. Radio is also more and more delivered via wire-line services such as cable television.

Perhaps the most common provisioning method for video-conferencing has included the use of a combination of copper pairs using inverse multiplexing methods to deliver the necessary bandwidth over multiple local loop connections and therefore multiple telephone connections via the telephone network.

The use of the telephone system for video-conferencing points out probably the most representative property of the telephone network in providing dedicated circuits at low jitter. However, the telephone system is considered to have a ubiquitous reach, further expansion necessitating large infrastructure expenses. Free space radio waves, a broadcast medium, share this property also by channeling data transmission but are limited by a limited reach and weather conditions. The cable television network shares the same property through channelisation. The extension of the reach of the cable television network involves infrastructure expenses. Initially the cable television network was a broadcast-only medium but recently has provided for two-way communications enabling tele-text and video-on-demand services.

By far the most flexible and the most reconfigurable from the above description is the telephone network. Dedicated connections can be established between POTS terminations connected to local loops via methods commonly known as circuit switching. The bandwidth utilization of the telephone system was considered to be sub-optimal. The most extensive use of the telephone network has been person-to-person voice communications. Voice communications have a 40% activity leading to a 60% waste of the available dedicated bandwidth.

The telephone system was also designed to be fault tolerant through redundancy. The redundant implementation was achieved through the use of redundant telephone switches, redundant inter-telephone switch lines known as telephone trunks, telephone trunks being deployed in a geographically separated manner, etc.

The last few decades have benefited from an increased demand for telecommunication services and in particular for data services. Solutions were sought for the provision of data services in a reliable fashion at a low cost. The reliability was provided through the use of what is know as packet switching technologies in data transport networks which in combination guarantee the transport of data segmented into Protocol Data Units (PDU) loosely known as packets. The use of the term packet is very common although technically it does not include all data transport technologies such as cell switching and frame data transport. In this description packet switching is understood to mean PDU switching.

The segmentation of the conveyed data in PDUs ensures an optimization of bandwidth utilization. Transmission reliability is provided through the independent routing of each PDU in the data transport network which includes the routing of PDUs around failed data transport equipment towards destination data network nodes specified in a PDU header. Alternative data paths through the data transport network are provided through a web of interconnections between data network nodes.

As opposed to circuit switching in the telephone network where a communications session is established once and redundant circuits are available on a hot-standby basis, most common forms of packet switching are characterized as connection-less data transport due to the continuous independent routing of each PDU. Independent routing of each PDU adds a measurable delay in data transport.

Most common forms of packet switching data transport is also characterized as best-effort. PDUs may be dropped due to the webbed interconnection of data network nodes to prevent the PDUs from looping around and/or an overly long search in finding a route to an intended destination. Reliable transport is provided through retransmission of PDUs. However, by using these methods, PDUs incur transport delays—streams of data are said to be subject to jitter due to the variance in the transport time of the constituent PDUs.

In the recent years data transport networks have enjoyed an explosive deployment, the installed base approaching that enjoyed by the telephone network. Deployment, maintenance, and operation costs are comparatively lower which, coupled with a flexible expansion ability, an explosive increase in bandwidth, and a quick implementation and delivery of new services; have put a pressure on traditional communication services, including the streaming data services mentioned above, to consider packet switching technologies as a means of data transport. Pressure also comes from communication service providers with a need to eliminate the maintenance and administration of separate networks.

A source of data transport delay and jitter is the data switching equipment used in the data transport networks such as data switching nodes. The independent routing of every PDU involves a lot of processing. Data network equipment, data transport protocols and PDU switching methods have been developed to mimic circuit switching by providing the apriori establishment of data transport paths known as virtual circuits. However, although providing economies at high bandwidths the above do not provide end-to-end solutions. Perhaps these solutions will be implemented end-to-end in the near future as higher and higher bandwidths are required at the edge of data transport networks. For the present, these remain data network backbone solutions. Interim end-to-end solutions are required to be implemented on current equipment.

A current effort to deliver streaming data services over packet switching technologies includes, but is not limited to Voice-over-IP (VoIP) services. Perhaps one of the most supported data transport protocol is the Internet Protocol (IP), perhaps the most flexible technology, and most definitely having the highest market penetration to the edge of the ubiquitous international data transport network known as the Internet. As data transport protocols such as Asynchronous Transfer Mode (ATM), Synchronous Optical Hierarchy (SONET), Frame Relay (FR), etc. exist and are used. These data transport protocols address high bandwidth operation of data transport networks which makes them ideal for backbone networks. Currently streaming data services are provided over these high bandwidth data transport protocols but further development is necessary to support streaming data services over the IP protocol.

The delivery of streaming data services whether audio streaming for: telephony services, audio-conferencing, internet radio, etc.; whether video streaming for: video-phone services, video-conferencing, Internet television, etc.; or data streaming for: tele-text, news services, stock ticker services, etc.; includes data transport protocol and hardware level support.

Regardless of the data transport technology, PDUs are transported over data links between the data network nodes at maximum transmission rates and incurring only data transmission delays. Improvements in data transport protocols such as VoIP are described elsewhere. Inefficient routing of PDUs leads to delays in conveying PDUs and is the subject of the present description.

Although, as presented above, there exist a myriad of streaming data services and surely more streaming data services will be developed and provisioned in the future, all these services are categorized by being delay sensitive due to the nature of each service: audio streaming is delay sensitive affecting the ability to discern speech, video streaming is delay sensitive affecting the ability to discern a motion picture, data streaming is delay sensitive affecting timely reaction to the information conveyed (e.g. stock ticker service). Audio streaming and video streaming are also sensitive to jitter—data streaming being comparatively less sensitive.

To some extent these streaming data services are also sensitive to PDU loss: Audio streaming is less affected when compared to video streaming due to the ability of the human aural system to make use of a conversation context (ref. noisy party) making up for lost sound segments. Video streaming is relatively more sensitive to PDU loss due to the high bandwidth required for its provision and the amount of data conveyed in each PDU. Video data encoding protocols are under development to provide a relief with the goal to allow for complete loss of PDUs amounting to several sequential video frames. Data streaming (stock ticker) tolerates no loss of PDUs but the burden is relieved by a relatively low transport bandwidth requirement in comparison with audio streaming and video streaming.

There is a need to develop methods and apparatus for real time evaluation of the performance of data network equipment in provisioning delay sensitive data services such as, but not limited to, streaming data services.

### SUMMARY OF THE INVENTION

In accordance with an aspect of the invention, a method of evaluating the processing performance of a data switching node is provided. The method includes a sequence of steps. PDU header information is extracted from each received PDU. An entry in a receive trace record is populated with the extracted information and a time stamp. The PDU is processed by a switching function of the data switching node. An entry in a transmit trace record is populated with information resulting from the switching function and a time stamp. The processing performance of the data switching node is evaluated based on the information held in the receive and transmit trace record entries.

In accordance with another aspect of the invention, a data switching node adapted to evaluate its switching performance is provided. The data switching node includes as enabling elements: a PDU classifier extracts header information from PDUs received at the data switching node, time stamped information regarding received PDUs is held in a receive trace record, time stamped information regarding processed PDUs is held in a transmit trace record, and a processor uses the time stamped information held in the receive and transmit trace records to evaluate the performance of the data switching node.

The advantages are derived from an availability of an assessment of data transport latencies, data conveyance jitter and data segment loss to enable the provisioning of streaming data services.

### BRIEF DESCRIPTION OF THE DRAWING

The features and advantages of the invention will become more apparent from the following detailed description of the preferred embodiment with reference to the attached diagram wherein:

FIG. 1 is a schematic diagram showing elements implementing a data switching node providing real time evaluation of the performance thereof in conveying streaming data service PDUs in accordance with a preferred embodiment of the invention.

It will be noted that in the attached diagram like features bear similar labels.

### DETAILED DESCRIPTION OF THE EMBODIMENTS

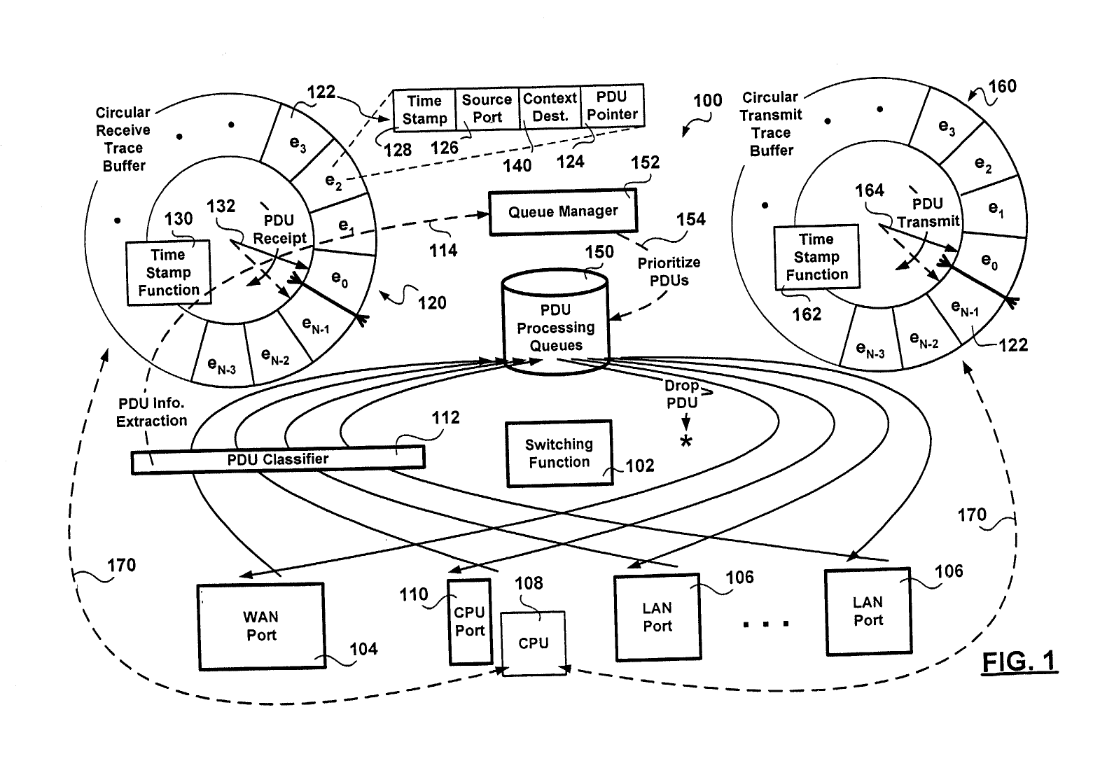

FIG. 1 is a schematic diagram showing elements implementing a data switching node providing real time evaluation of the performance thereof in conveying streaming data service PDUs in accordance with a preferred embodiment of the invention.

A data switching node 100, performing a switching function 102 on PDUs received via: a Wide Area Network (WAN) port 104, Local Area Network (LAN) ports 106; or PDUs generated by a processor (CPU) 108 via a CPU port 110.

The WAN port 104 is representative of a backbone-side data transfer interface having a relatively high data throughput. The LAN ports 106 are representative of distribution-side data transfer interfaces having relatively moderate data throughputs. The data switching node 100 aggregates the data throughput received via the LAN ports 106 onto the WAN port 104 and de-aggregates data throughput received from the WAN port 104 to the LAN ports 106. The invention is not limited to the number of ports 104/106/110 shown. Further, the WAN port 104, as it conveys audio streams in support of VoIP, may include support for Time Division Multiplexing (TDM) data transport protocols.

A PDU classifier 112 is used in examining each PDU and extracting header information (114) in support of the switching function 102 as well as in identifying each PDU in support of the performance evaluation function.

In accordance with the invention, the performance evaluation function is provided via a receive trace record shown, in accordance with a preferred implementation, as a circular receive trace buffer 120. The receive trace record includes entries 122 having field specifiers respectively specifying at a minimum: a PDU pointer 124 specifying a memory address at which the corresponding PDU is stored for processing in a PDU processing buffer 150, a source port 126 via which the PDU was received and a time stamp 128 provided by a time stamp function 130 associated with the receive trace record 120. Other information my be stored therein including, but not limited to, a destination context 140 used by the switching function 102 to determine an output port 104/106/110 to forward the PDU to. Depending on the data transfer protocol used, entries 122 in the receive trace record 120 include minimal information to identify each streaming data service PDU.

The size N of the circular buffer used in implementing the receive trace record 120 may be determined by a PDU processing throughput of the data switching node 100 specified at the development thereof—the size thereof may be set manually, through a management console and/or, monitored and adjusted via a higher level performance evaluation process (not shown).

The circular receive trace buffer 120 has an index 132 which keeps track of the next entry to be populated on the receipt of each PDU.

The extracted PDU header information 114, is also provided to a queue manager 152 characterizing received PDUs into separate processing queues and prioritizing 154 the processing of the PDUs in the processing buffer 150. The switching function 102 determines a destination port 104/106/110 for each PDU in the processing buffer 150. Methods of PDU processing are described elsewhere.

PDU processing is a time intensive task and introduces a delay in the overall end-to-end conveyance of PDUs known as processing delay. The prioritization of PDU processing 154 introduces a jitter in the end-to-end conveyance of PDUs as PDUs may be processed by the switching function 102 out of sequence with respect to the sequence in which the PDUs were received due to processing priorities specified in the associated PDU header information 114 extracted.

In accordance with the invention, a transmit trace record 160 is used in evaluating processing latency, jitter, and PDU loss in determining an efficiency in processing PDUs. The transmit trace record 160 is implemented preferably, but not limited to, a circular transmit trace buffer. The circular transmit trace buffer 160 stores entries 122 and is associated with a time stamp function 162 populating entries 122 pointed to by an index pointer 164 advanced on the processing of each PDU.

Entries 122 of the transmit trace record 160 may include a destination port designation 104/106/110 in the destination context field 140. Dropped PDUs will either not have corresponding entries 122 in the transmit trace record 160 or, corresponding transmit trace record 160 entries 122 may specify that the PDU was dropped by storing a reserved value in the destination context field 140.

In evaluating the performance of the data switching node 100, the CPU 108 correlates 170 entries 122 in the receive trace record 120 and the transmit trace record 160 to determine the latency, the jitter and/or drop incurred in processing each PDU. The processing latency is determined by the comparison of the time stamp values held in the time stamp specifiers 128 of corresponding entries 122. The processing jitter for PDUs associated with a particular data stream is determined by comparing sequences of processing latencies of PDUs associated with the data stream. PDU drop instances are determined from the transmit trace buffer 160.

The performance evaluations are performed by the processor 108 on a regular basis including: a regimented schedule and upon the transmission of each PDU. The rate at which the trace records 120/160 are inspected to perform the performance evaluation is matched with the PDU processing rate of the data switching node 100—otherwise the performance estimation process is inefficient losing the ability to provide a real time accurate and precise performance evaluation.

A debug mode of operation of the data switching node 100 is provided in accordance to which, an error condition experienced by the data switching node 100 triggers an inspection of the receive 120 and transmit 160 trace buffers to determine events which occurred prior to the error condition.

The embodiments presented are exemplary only and persons skilled in the art would appreciate that variations to the above described embodiments may be made without departing from the spirit of the invention. The scope of the invention is solely defined by the appended claims.

We claim:

1. A data switching node evaluating Protocol Data Unit (PDU) switching performance comprising:
a. a PDU classifier extracting header information from PDUs received via a plurality of ports associated with the data switching node;
b. a receive trace record having entries, each receive trace record entry specifying timed information regarding a corresponding received PDU;
c. a switching function processing PDUs;
d. a transmit trace record having entries, each transmit trace record entry specifying timed information regarding a corresponding processed PDU; and
e. a processor using the information stored in trace record entries to evaluate the performance of the switching function.

2. A switching data node as claimed in claim 1, wherein the switching data node further comprises a timer.

3. A switching data node as claimed in claim 1, wherein each one of the trace records comprises a circular buffer storing the trace record entries.

4. A switching data node as claimed in claim 3, wherein each one of the circular buffers includes an index pointer specifying a next trace record entry to be populated.

5. A switching data node as claimed in claim 1, wherein the number of trace record entries associated with each one of the trace records is prespecified corresponding to a designed PDU processing throughput of the data switching node.

6. A switching data node as claimed in claim 1, wherein the number of trace record entries associated with each one of the trace records is variable, the number of record entries being adjustable via a one of a manual setting, management console, and a higher level protocol optimizing resources available for a current PDU processing throughput of the data switching node.

7. A switching data node as claimed in claim 1, wherein each receive trace record entry further comprises specifiers holding:
a. a time value indicative of the time at which the corresponding PDU was deemed to have been received; and
b. identifying information corresponding to the received PDU.

8. A switching data node as claimed in claim 7, wherein the identifying information corresponding to the received PDU further comprises a specification of a location at which the PDU is stored pending processing.

9. A switching data node as claimed in claim 7, wherein the identifying information corresponding to the received PDU further comprises a specification of a port via which the PDU was received.

10. A switching data node as claimed in claim 7, wherein the identifying information corresponding to the received PDU further comprises a specification of a destination context corresponding to the received PDU.

11. A switching data node as claimed in claim 1, wherein each transmit trace record entry further comprises specifiers holding:
a. a time value indicative of the time at which the corresponding PDU was deemed to have been processed; and
b. identifying information corresponding to the processed PDU.

12. A switching data node as claimed in claim 11, wherein the identifying information corresponding to the processed PDU further comprises a specification of a location at which the PDU was stored pending processing.

13. A switching data node as claimed in claim 11, wherein the identifying information corresponding to the processed PDU further comprises a specification of a port via which the PDU was received.

14. A switching data node as claimed in claim 11, wherein the identifying information corresponding to the processed PDU further comprises a specification of a destination context corresponding to the processed PDU.

15. A switching data node as claimed in claim 14, wherein specification of the destination context corresponding to the processed PDU includes a port via which the PDU is to be forwarded towards an intended destination.

16. A switching data node as claimed in claim 14, wherein specification of the destination context corresponding to the processed PDU includes a specification that the PDU is to be dropped.

17. A method of evaluating a processing performance of a data switching node forwarding Protocol Data Units (PDUs) comprising steps of:
a. extracting PDU header information from a received PDU;
b. populating an entry in a receive trace record held by the data switching node;
c. processing the received PDU;
d. populating an entry in a transmit trace record held by the data switching node; and
e. evaluating the processing performance based on information held in trace record entries.

18. A method as claimed in claim 17, wherein populating a one of the trace record entries with information the method further comprises a step of populating a PDU pointer entry with a value indicative of a location at which the corresponding PDU is temporarily stored.

19. A method as claimed in claim 17, wherein populating a one of the transmit trace record entries with information the method further comprises a step of populating the transmit trace record entry with information indicative of a PDU discard in the case of a PDU drop instance.

20. A method as claimed in claim 19, wherein evaluating the performance of the data switching node the method further comprises a step of calculating a PDU drop indication corresponding to each stream of data conveyed by the data switching node.

21. A method as claimed in claim 19, wherein evaluating the performance of the data switching node the method further comprises a step of calculating a PDU drop indication corresponding to a current operational state of the data switching node.

22. A method as claimed in claim 17, wherein populating a one of the receive trace record entries with information the method further comprises a step of populating a time stamp specifier associated with the receive trace entry with a time value indicative of the time at which the PDU was deemed to be received.

23. A method as claimed in claim 18, wherein populating a one of the transmit trace record entries with information the method further comprises a step of populating a time stamp specifier associated with the transmit trace entry with a time value indicative of the time at which the PDU was processed.

24. A method as claimed in claim 22, wherein evaluating the processing performance the method further comprises a step of determining a PDU processing delay by calculating the difference between time stamp values held in a receive trace record entry and a transmit trace record entry corresponding to the PDU.

25. A method as claimed in claim 23, wherein evaluating the processing performance the method further comprises a step of determining an average PDU processing delay incurred at the data switching node by calculating a average of the PDU processing delays incurred by corresponding PDUs.

26. A method as claimed in claim 23, wherein evaluating the processing performance the method further comprises a step of determining a PDU conveyance jitter for a stream of data by determining the distribution of PDU processing delays incurred by a plurality of PDUs associated with a stream of data.

27. A method as claimed in claim 23, wherein evaluating the processing performance the method further comprises a step of determining a PDU conveyance jitter for the data switching node by determining the distribution of PDU processing delays incurred by a plurality of PDUs forwarded by the data switching node.
